(19) United States
(12) Patent Application Publication
(10) Pub. No.: US 2006/0197455 A1
(43) Pub. Date: Sep. 7, 2006

(54) External electrode fluorescent lamp

(75) Inventors: Ki Duck Park, Seoul (KR); Jeong Min Han, Seoul (KR)

Correspondence Address: SEYFARTH SHAW LLP, 55 E. MONROE STREET, SUITE 4200, CHICAGO, IL, 60603-5803, US

(73) Assignee: Boe Hydis Technology Co., Ltd.

(21) Appl. No.: 11/142,628

(22) Filed: Jun. 1, 2005

(30) Foreign Application Priority Data
Mar. 3, 2005 (KR) 10-2005-0017682

(51) Int. Cl. H01J 13/46

(52) U.S. Cl. 315/56

(57) ABSTRACT

Disclosed is an external electrode fluorescent lamp for use in a backlight improved in electrical discharge property by coating dielectric material on the inner sides of external electrodes. The external electrode fluorescent lamp comprises a lamp tube containing electric-discharge gas and fluorescent material to provide an electric-discharge space within the lamp tube; external electrodes arranged in a form of circumferentially surrounding outer surfaces of opposite ends of the lamp tube, wherein a discharge voltage is externally applied to the external electrode; and dielectric layers positioned on the inner wall of the lamp tube to correspond to the external electrodes, respectively.

### BACKGROUND OF THE INVENTION

1. Field of the Invention

The present invention relates to an external electrode fluorescent lamp and more particularly to an external electrode fluorescent lamp for use in a backlight, wherein the fluorescent lamp is improved in electrical discharge property by coating dielectric material on the inner sides of the external electrodes.

2. Description of the Prior Art

Cold cathode fluorescent lamps have been widely spread as limit-emitting devices generally employing plasma discharge. Recently, external electrode fluorescent lamps have been developed and widely spread, which have an extended life span and allow a number of such fluorescent lamps to be driven in parallel while employing plasma discharge.

A cold cathode fluorescent lamp is formed by inserting a cylindrical nickel electrode into each end of a lamp tube typically having a diameter of several millimeters and by hermetically sealing the lead wires of the electrodes and both ends of the lamp tube, so that light of high luminosity can be produced. Such a cold cathode fluorescent lamp has an advantage in that the areas formed with the electrodes are also capable of being used as light emitting areas. However, such a cold cathode fluorescent lamp has a disadvantage in that it is very difficult to insert nickel electrodes into both ends of a lamp tube, and the electrodes of the lamp are frequently damaged while joining them with lead wires thereof by soldering. In addition, because the electrodes are inserted into the lamp tube, the electrodes are damaged by a sputtering phenomenon caused as the gas filled in the lamp tube is electrically discharged and thus the life span of the lamp is shortened.

Meanwhile, the above-mentioned external electrode fluorescent lamp has an advantage as compared to a cold cathode fluorescent lamp in that it is possible to minimize the loss of electrodes caused the sputtering phenomenon resulted from electric-discharge because electrodes are formed outside of a lamp tube, and in that the number of inverters can be reduced because a plurality of such lamps can be driven in parallel when they are connected with each other and used simultaneously. In addition, attempts have been made to reduce an input voltage for such an external electrode fluorescent lamp by increasing wall voltage so as to reduce power consumption. In this regard, a measurement for increasing the length of electrodes, i.e. for increasing the cross-sectional area of electrodes formed outside of the lamp tube or for shortening the discharge path has been employed in the prior art.

However, if such an external electrode fluorescent lamp is applied as an optical part of another product as in a backlight of a liquid crystal display, it will be necessary to limit the length of the lamp tube to a predetermined size. Accordingly, if the cross-sectional area of electrodes are increased or the electric-discharge path is shortened so as to reduce the input voltage of an inverter as described above, there will be a problem of deteriorating the luminosity of the lamp.

### SUMMARY OF THE INVENTION

Accordingly, the present invention has been made to solve the above-mentioned problems occurring in the prior art, and an object of the present invention is to provide an external electrode fluorescent lamp, of which power consumption is reduced by coating dielectric material on the inner sides of external electrodes and using electric charges accumulated on the dielectric material as wall charges.

In order to achieve the above-mentioned object, there is provided an external electrode fluorescent lamp for use in a backlight, wherein the lamp comprises: a lamp tube containing discharge gas and fluorescent material and providing a discharge space for the lamp; external electrodes arranged in a form of circumferentially surrounding outer surfaces of opposite ends of the lamp tube, respectively, wherein a discharge voltage is externally applied to the external electrodes; and charge accumulation areas interposed between the lamp tube and the external electrodes, respectively, so that the charge accumulation areas can additionally accumulate electric charges.

In this construction, adhesive means containing silver (Ag) is interposed between the lamp tube and the external electrode.

### BRIEF DESCRIPTION OF THE DRAWINGS

The above and other objects, features and advantages of the present invention will be more apparent from the following detailed description taken in conjunction with the accompanying drawings, in which:

FIG. 1 shows an external electrode fluorescent lamp according to a first embodiment of the present invention; and

FIG. 2 shows an external electrode fluorescent lamp according to a second embodiment of the present invention.

### DETAILED DESCRIPTION OF THE PREFERRED EMBODIMENTS

Hereinafter, a preferred embodiment of the present invention will be described with reference to the accompanying drawings.

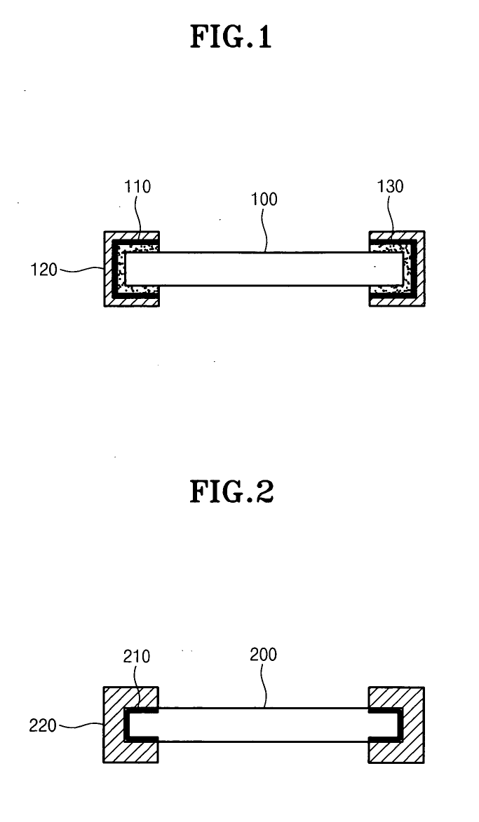

FIG. 1 shows an external electrode fluorescent lamp for use in a backlight according to a first embodiment of the present invention.

As shown in the drawing, the inventive external electrode fluorescent lamp for use in a backlight comprises a lamp tube 100, which emits light when power is externally supplied, dielectric layers 110 each formed to circumferentially surround outer surface of one end of the lamp tube, external electrodes 120 each arranged in a form to surround corresponding one of the dielectric layers 110 so as to supply power to the lamp tube 100, and adhesive means containing silver (Ag), which adhesive means is interposed between -the dielectric layers 110 and the external electrodes 120.

The lamp tube 100 is formed from glass having a predetermined dielectric coefficient and superior in light transmissivity to provide an electric-discharge space. For this purpose, fluorescent material is coated on the inner wall of the lamp tube 100 and electric-discharge gas is introduced into the interior of the lamp tube 100. The introduced electric-discharge gas produces ultraviolet (UV) ray through electric-discharge, and as the fluorescent material coated on the inner wall of the lamp tube 100 is excited by the UV ray produced in the above-mentioned manner and then stabilized, light in the visible range is emitted.

As described above, it is necessary for electric-discharge to be produced within the lamp tube 100 so as to make it possible for light to be produced in the lamp tube, which can be implemented by supplying power to the external electrodes 120 located on the external circumferential parts of the lamp tube 100. Here, the external electrodes 120 are formed from conductive material, preferably from metallic material, such as nickel (Ni) or copper (Cu).

Meanwhile, the adhesive means 130 containing silver (Ag), which is interposed between the external electrodes 120 and the dielectric layers 110, serves to make metal, i.e., the external electrodes 120 and the dielectric layers 110 tightly contact with each other because the silver grains contained in the adhesive means is superior in electric conductivity and thermal-expansion property.

According to the first embodiment, the dielectric layers 110 are formed on the lamp tube 100 before the external electrodes 120 are positioned, so that the dielectric layers are interposed between the lamp tube 100 and the external electrodes 120. This is to increase a wall voltage by using electric charges, which are accumulated on the dielectric layers 110 when alternating current gas discharge is caused within the lamp tube 100, as wall charges, thereby reducing the input voltage and hence power consumption as compared to an existing external electrode fluorescent lamp.

Now, description is made in terms of the effects obtained by providing the dielectric layers 110 as described above in some more detail. The electric-discharge gas within the lamp tube 100 is transformed into ions and electrons through ionization when alternating current gas discharge is caused. The transformed ions and electrons are moved from the negative pole electrode to the positive pole electrode or from the positive pole electrode to the negative pole electrode. At this time, the ions and electrons come into collision with other electric-discharge gas, thereby continuously producing ions and electrons and thus developing a plasma state. Accordingly, electric-discharge is caused within the lamp tube 100. In that event, ions (positive electric charges) or electrons (negative electric charges) are moved and accumulated on the surfaces of the external electrodes 120 without disappearing, which are called as “wall charges” and the voltage developed by the wall charges is called as “wall voltage” Vw. The wall charges accumulated on each external electrode 120 are mixed with input electric charges produced by a next waveform, that is, an alternating voltage, whose polarity inputted into the external electrodes 120 is changed, and then moved toward the opposite side external electrode 120. Consequently, this results in a memory effect increasing the number of electric charges. Therefore, the voltage for supporting electric discharge of the lamp, Vs, equals to the input voltage Vo applied to the external electrodes 120 plus the wall voltage Vw developed by the wall charges as expressed by the following equation:
Vs=Vo+Vw

In the first embodiment of the present invention, a dielectric layer 110 is interposed between each external electrode 120 and the lamp tube 100. If a voltage is applied to the external electrodes 120, each dielectric layer 100 serves as a capacitor, thereby accumulating electric charges, and then if a voltage having a polarity different from that of the previously applied voltage is applied to the external electrodes 120, the dielectric layers 100 will discharge the accumulated electric charges and accumulate electric charges having a polarity different from that of the previously accumulated electric charges. That is, the electric charges accumulated on the dielectric layers 110 serve as wall charges, which develop a wall voltage, thereby increasing the electric-discharge voltage. Therefore, if the wall voltage Vw is increased under the condition of a voltage for supporting electric-discharge of the lamp, Vs, required for forming a predetermined intensity of tube current due to the formation of the dielectric layers, it is possible to reduce the level of an input voltage Vo inputted into the external electrodes 120.

TABLE 1

| Tube current | Conventional | The inventive | Gain |
|---|---|---|---|
| (mA) | EEFL (V) | EEFL (V) | voltage (V) |
| 3.0 | 1002 | 973 | 29 |
| 3.5 | 1175 | 1157 | 18 |
| 4.0 | 1348 | 1318 | 30 |
| 4.5 | 1514 | 1493 | 21 |
| 5.0 | 1681 | 1656 | 25 |
| 5.5 | 1848 | 1824 | 24 |

Table 1 shows experimental results, which were obtained by measuring lamp voltages required for obtaining a predetermined level of tube current for conventional external electrode fluorescent lamps without any dielectric layer and external electrode fluorescent lamps according to the first embodiment of the present invention in comparison. Here, the tube current is a measured factor which is proportional to and-has a direct influence on the luminosity of a fluorescent lamp; it is required to apply the same level of voltage for supporting electric discharge of the lamp, Vs, in order to obtain the predetermined level of tube current under a same condition.

FIG. 2 shows an external electrode fluorescent lamp according to the second embodiment of the present invention for use in a backlight. The second embodiment is same with the first embodiment as described above, except that dielectric layers 210 are each positioned on the inner wall of the lamp tube 200 at the opposite ends thereof to correspond to external electrodes 220.

Although the dielectric layers 210 are respectively positioned on the inner wall of the lamp tube 200 at the opposite ends thereof in the second embodiment of the present invention, the dielectric layers 210 can be effective in increasing the wall voltage Vw as in the first embodiment because they are positioned within an electric-discharge area formed between the corresponding external electrodes 220.

As described above, the inventive external electrode fluorescent lamp for use in a backlight has dielectric layers formed on the external wall of the lamp tube at the opposite ends before external electrodes are mounted on the lamp tube so that the dielectric layers are interposed between the external electrodes and the lamp tube. Alternatively, the dielectric layers may be formed on the inner wall of the lamp tube at the opposite ends thereof to correspond to the external electrodes, respectively. By this, it is possible to obtain a voltage for supporting the electric discharge of the lamp, the level of which voltage is same with that of an existing external electrode fluorescent lamp, even if an inverter input voltage is applied, which is lower in level than that of the existing external electrode fluorescent lamp, as the wall voltage is increased due to the formation of the dielectric layers. Therefore, with the inventive external electrode fluorescent lamp having dielectric layers, it is possible to obtain tube current and luminosity, the levels of which are same with those obtained in the existing external electrode fluorescent, even if an inverter input voltage is applied to the inventive fluorescent lamp, which is lower in level than that applied to the existing external electrode fluorescent lamp.

According to the present invention configured as described above, by using electric charges accumulated on dielectric layers due to a memory effect caused by the dielectric layers coated inside of external electrodes as wall charges, it is possible to increase a wall voltage while relatively reducing an inverter input voltage, thereby reducing power consumption.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An external electrode fluorescent lamp comprising:
a lamp tube containing discharge gas and fluorescent material and providing a discharge space for the lamp;
external electrodes arranged in a form of circumferentially surrounding outer surfaces of opposite ends of the lamp tube, respectively, wherein a discharge voltage is externally applied to the external electrodes; and
charge accumulation areas interposed between the lamp tube and the external electrodes, respectively, so that the charge accumulation areas can additionally accumulate electric charges.

2. An external electrode fluorescent lamp as claimed in claim 1, wherein each of the charge accumulation areas is provided with a dielectric layer formed by coating dielectric material.

3. An external electrode fluorescent lamp as claimed in claim 1, further comprising adhesive means containing silver (Ag) and each being interposed between the charge accumulation area and the external electrode.

4. An external electrode fluorescent lamp comprising:
a lamp tube containing discharge gas and fluorescent material providing a discharge space for the lamp;
external electrodes arranged in a form of surrounding outer surfaces of opposite ends of the lamp tube, respectively, wherein a discharge voltage is externally applied to the external electrode; and
dielectric layers arranged on the inner surface of opposite ends of the lamp tube to correspond to the external electrodes, respectively.

5. An external electrode fluorescent lamp as claimed in claim 4, further comprising adhesive means containing silver (Ag) and each being interposed between the lamp tube and the external electrode.
